(19) United States
(12) Patent Application Publication
(10) Pub. No.: US 2006/0031767 A1
(43) Pub. Date: Feb. 9, 2006

(54) Information recording and reproducing device

(75) Inventor: Hideta Nishizawa, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/192,034

(22) Filed: Jul. 29, 2005

(30) Foreign Application Priority Data
Aug. 3, 2004 (JP) 2004-226805
Jun. 28, 2005 (JP) 2005-188455

(51) Int. Cl. G11B 27/00

(52) U.S. Cl. 715/723

(57) ABSTRACT

Provided is a technique capable of eliminating unnecessary processing of transferring data that is not required by a play list when the play list registered at a transfer source is to be implemented at a transfer destination. In data transfer between recording and reproducing devices, to implement a play list file of one device on another device, only data portions corresponding to a play list are combined and transferred as one file. In addition, selection is made as to whether all moving image and audio files relative to the play list and the play list file are transferred or moving image and audio data portions registered in the play list file are combined and transferred as one moving image and audio data. Accordingly, it is possible to reduce a transfer data amount and an editing step number at the transfer destination.

### BACKGROUND OF THE INVENTION

1. Field of the Invention

The present invention relates to an information recording and reproducing device, such as a camcorder, for recording or reproducing information onto or from an information recording medium, and more particularly to a technique of transferring moving image and audio data encoded in an MPEG format etc. between two devices selected from information recording and reproducing devices including a camcorder, a DVD recorder, and an HDD recorder, and personal computers (PC's).

2. Related Background Art

Up to now, when an information recording and reproducing device for moving image and audio data, such as a camcorder, is used to edit moving image data recorded on a disk medium, processing to be generally performed includes deletion of moving image data on a file basis and virtual editing (non-destructive editing) using a play list. When a file containing the play list (play list file) is transferred through connection to another information recording and reproducing device or PC, it is necessary to transfer the play list file along with all moving image and audio data relative to the play list file.

For example, to implement a play list on a transfer-destination recording and reproducing device, a total amount of data to be transferred is obtained as below.
6,000,000 (bits/sec)×(80 (min)×60 (sec))=2.88×10¹⁰ (bits) (1)
Note that amount of encoded data for moving image and audio data is set to 6 Mbps in consideration of the maximum bit rate for MP@ML in MPEG2 being 15 Mbps.

Transfer of the data in a full speed mode of USB 1.0, which provides a transfer speed of 12 Mbps, requires the following transfer time.

$$2.88 \times {10}^{10} ( bits ) \div 12 \text{,} 000 \text{,} 000 ( bits \text{/} sec ) = 40 ( min ) \qquad ( 2 )$$

A time to transfer the play list file is added to the above time.

However, a total amount of data to be reproduced is obtained as below.

$$6 \text{,} 000 \text{,} 000 ( bits \text{/} sec ) \times ( 45 ( min ) \times 60 ( sec ) ) = 1.62 \times {10}^{10} ( bits ) \qquad ( 3 )$$

When the play list is implemented at the transfer destination, 1.08×10¹⁰ (bits) of data is left unused for reproduction thereof, which corresponds to a redundant transfer time. Examples of such a technique relating to a play list include one described in Japanese Patent Application Laid-Open No. 2003-006979 or the like.

Further, there is a possible case where a user at a transfer destination makes a request for actual editing by referring to a play list. The case will be described with reference to FIGS. 15 and 16. FIG. 16 is a flowchart showing an operation for the case. First, data portions not corresponding to a play list file are erased (step S1010). Then, portions corresponding to the play list file are registered as one file in a reproduction order described in a play list (step S10-20). Finally, the play list file is erased (step S1030), followed by the end of actual editing.

As described above, the conventional art has a problem in that, data that is not required by a play list is unnecessarily transferred when the play list registered at a transfer source is to be implemented at a transfer destination. As a ratio of a data amount corresponding to the play list to a total data amount of relative files is smaller, and as the number of moving image and audio files relative to a play list file is larger, a redundant transfer time increases. In addition, the execution of actual editing based on a play list at a transfer destination requires excess processing including erasing moving image and audio data and erasing a play list file, which imposes a burden on a user.

### SUMMARY OF THE INVENTION

The present invention has been made in view of such current situations, and therefore has an object to eliminate unnecessary processing of transferring data that is not required by a play list when the play list registered at a transfer source is to be implemented at a transfer destination.

According to the present invention, there is provided an information recording and reproducing device, including:
an information recording and reproducing circuit adapted to record and reproduce moving image and audio data and a play list file;
a registration circuit adapted to register the moving image and audio data on a recording medium as a file;
a creation circuit adapted to create a play list file having a reproduction order registered therein, the reproduction order being used for reproducing entire or a part of files registered in the recording medium in a desired order; and
an indication circuit adapted to, in a case where the play list file is to be transferred and recorded to a recording medium of another device, combine moving image and audio data portions registered in the play list file, and transfer and record the moving image and audio data portions to the recording medium as one moving image and audio file.

### BRIEF DESCRIPTION OF THE DRAWINGS

FIG. 1 illustrates a data transfer method according to the present invention;

FIG. 2 illustrates a method of transferring data between recording and reproducing devices according to a conventional example;

FIG. 3 shows a sequence layer and a GOP layer as a data structure in a case where moving image data is structured in an MPEG2 format;

FIG. 4 shows kinds of data included in a sequence header;

FIGS. 5A and 5B show inter-frame prediction in a case of an open GOP and in a closed GOP, respectively;

FIG. 6 illustrates a structure of a GOP header;

FIG. 7 is a block diagram showing an MPEG encoder;

FIG. 8 is a block diagram showing an MPEG decoder;

FIGS. 9A and 9B are conceptual diagrams of synchronization of systems;

FIG. 10 illustrates a data structure on a disk;

FIG. 11 shows file information;

FIGS. 12A and 12B show time map information;

FIG. 13 shows play list information;

FIG. 14 illustrates a procedure for reproducing a play list;

FIG. 15 illustrates actual editing by referring to a play list;

FIG. 16 is a flowchart showing an operation for the actual editing by referring to a play list;

FIG. 17 is a block diagram showing a structure of an information recording and reproducing device according to the present invention;

FIG. 18 shows an example of data transfer according to the present invention;

FIG. 19 shows a data structure within a transfer-source recording medium;

FIGS. 20A and 20B illustrate an operation display unit upon transfer determination;

FIG. 21 is a flowchart showing the data transfer method according to the present invention;

FIG. 22 illustrates selection of transfer portion (when a designated portion matches GOP boundaries);

FIG. 23 illustrates selection of transfer portion (when a designated portion matches a GOP boundary);

FIG. 24 illustrates selection of transfer portion (when a designated portion matches a GOP boundary);

FIG. 25 illustrates selection of transfer portion (when a designated portion does not match GOP boundaries);

FIG. 26 shows a data structure before transfer and a data structure after transfer;

FIG. 27 shows a data structure within a transfer-destination recording medium;

FIG. 28 shows a file structure at a transfer destination after execution of a method of transferring a play list according to a conventional example;

FIG. 29 shows a file structure at a transfer destination after execution of a method of transferring a play list according to the present invention;

FIG. 30 shows an example of execution of transfer from a recording medium;

FIG. 31 shows an example of execution of transfer indication from a recording medium; and

FIG. 32 is a flowchart showing a method of transferring a play list from a recording medium.

### DESCRIPTION OF THE PREFERRED EMBODIMENTS

Next, best mode of embodiments for carrying out the present invention is explained in detail by referring to the drawings. Note that, in the following explanation, an extension of a play list file is defined as “.plf”, and an extension of a moving image and audio data file is defined as “.mpg”.

(Data Structure and Sequence Header in MPEG)

An MPEG data stream includes a video stream and an audio stream. The video stream and the audio stream are multiplexed with system information and packed to form a system data stream. The MPEG data stream has six layers including a sequence layer, a group of pictures (GOP) layer, a picture layer, a slice layer, a macro block (MB) layer, and a block layer. A header is provided to a head of each of those layers except the MB layer.

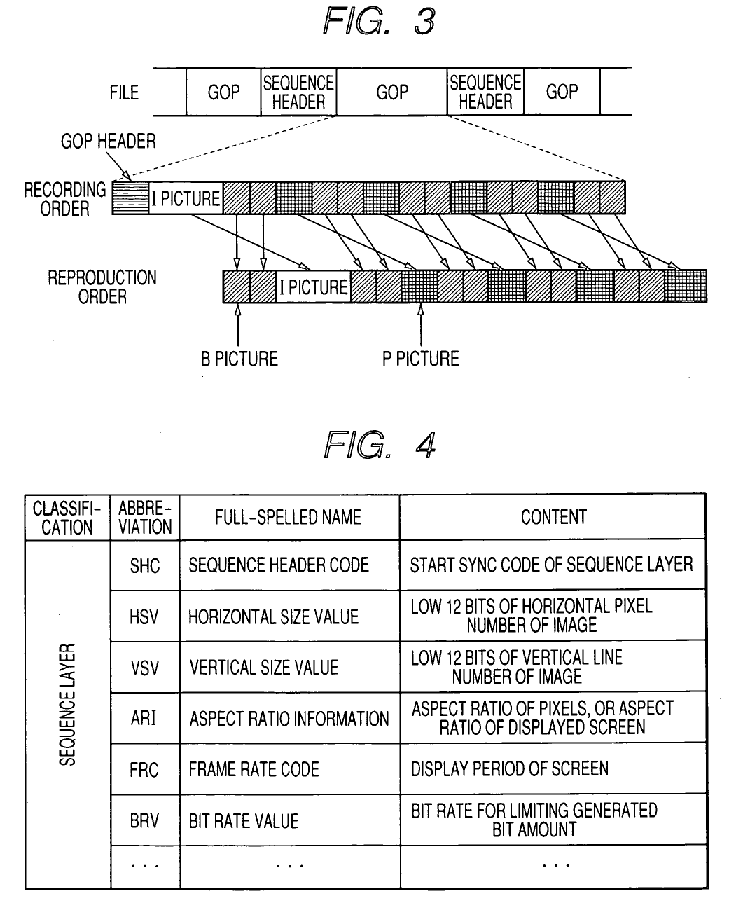

FIG. 3 schematically shows the sequence layer and the GOB layer as a data structure in a case where the moving image data is structured in an MPEG2 format. FIG. 4 shows kinds of data included in the sequence header. The sequence header designates parameters such as a size of an image, an aspect ratio (length-to-width ratio of an image), a picture rate, and amount of encoded data.

(Explanation on GOP and Picture)

Digital moving image data is structured by sequentially reproducing pictures. FIG. 3 shows a data structure in a case where the digital moving image data is structured in an MPEG2 format. A GOP shown here is a unit in which several pictures are grouped. The image data has three kinds of data including an I picture, a P picture, and a B picture. The I picture is encoded without referring to other picture information. The P picture is encoded by referring to I picture or P picture located ahead, and the B picture is encoded by referring to I picture or P picture each respectively located ahead and behind. As shown in FIG. 3, a recording order of the encoded data is different from a reproduction order thereof.

As shown in FIGS. 5A and 5B, there are two kinds of GOP; an open GOP (a) and a closed GOP (b). In the open GOP (a), a first B picture in the GOP refers to an I picture or a P picture located in the previous GOP. The closed GOP (b) is independent, and pictures are referred to one another within the same GOP.

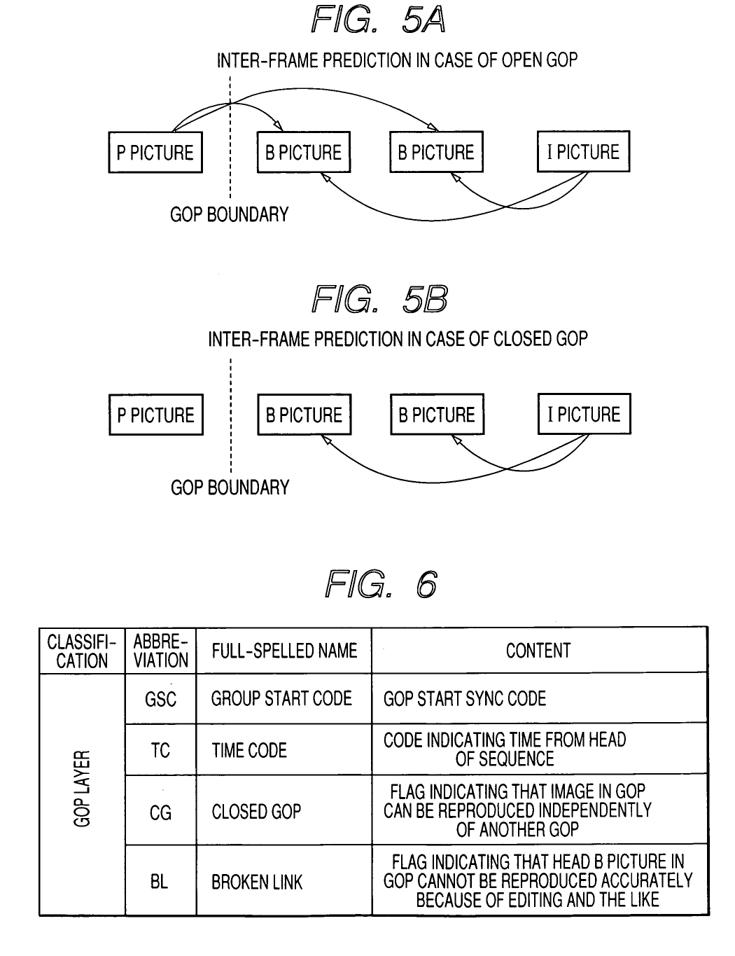

As shown in FIG. 6, a GOP header is provided with a closed GOP flag and a broken link flag. The closed GOP flag is set at the time of encoding, showing that some of the first B pictures are independent of the previous GOP. The broken link flag is set when a bit stream, which is composed of GOP's other than a closed GOP, is cut and combined upon editing. When the broken link flag is set, a decoder cannot display some of the first B pictures in the GOP.

(Encoding Algorithm in MPEG)

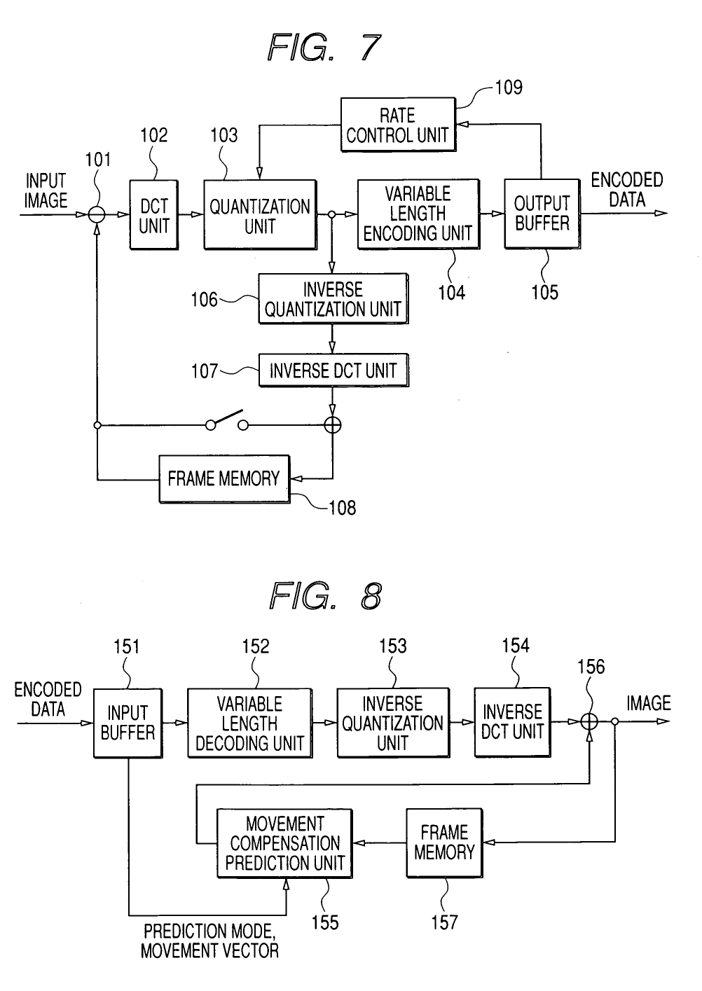

FIG. 7 shows a block diagram of an MPEG encoder and FIG. 8 shows a block diagram of an MPEG decoder. In the MPEG encoder, a differentiator 101 refers to I pictures and P pictures to obtain a difference with respect to an input image. A correlation in a frame is removed from the differential signal by a discrete cosine transform (DCT) unit 102, and the resultant signal is subjected to a quantization in a quantization unit 103.

A quantization output value is expressed by a variable length encoding unit 104, which assigns codes different in length based on a frequency of occurrence of the quantization output value, and transferred to an output buffer 105. Meanwhile, in order to use I pictures and P pictures as a reference image for movement prediction, the I pictures and the P pictures are subjected to inverse quantization in an inverse quantization unit 106, and then to local decoding in an inverse DCT unit 107 through inverse DCT and movement compensation, to be made into an image similar to the image obtained by data decoding. The resultant image is stored in a frame memory 108 to be used for movement prediction of B pictures and P pictures.

A rate control unit 109 returns amount of encoded data that is transferred to the output buffer 105 to the quantization unit 103, and changes values in a quantization table based on this bit rate to control bit rate of data to be quantized next, to thereby control rate.

In the MPEG decoder, encoded data (bit stream) is stored in an input buffer 151. The encoded data is subjected to processings of invariable length decoding in a variable length decoding unit 152, inverse quantization in an inverse quantization unit 153, and inverse DCT in an inverse DCT unit 154, and finally movement compensation prediction data stored in a movement compensation prediction unit 155 is added thereto in an adder 156, to be outputted. Of the decoded pictures, I pictures and P pictures are stored in a frame memory 157 for movement compensation to be used for movement compensation.

(Explanation on Time Stamp and Synchronization)

Under the MPEG standard, a plurality of digital signals as elements composing digital contents such as video and audio can be multiplexed to be a single bit stream. When such multiplexed data is reproduced, the data need to be divided into digital signals, which need to be reproduced in synchronization.

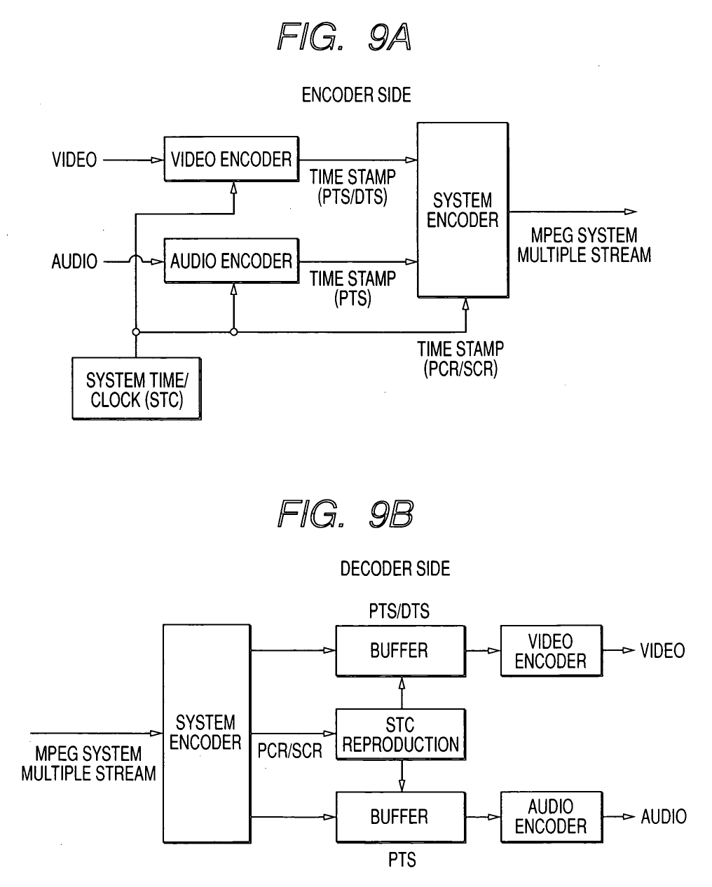

As shown in FIGS. 9A and 9B, in a multiple stream, a system encoder and a system decoder of MPEG2 encode time information of program clock reference (PCR) or system clock reference (SCR), and time information of presentation time stamp (PTS) and decoding time stamp (DTS), to thereby perform synchronized reproduction with high precision at a decoder side. Here, PCR and SCR are used as the reference, and PTS and DTS are added to each unit of encoding of video and audio.

(File Management and Access Method)

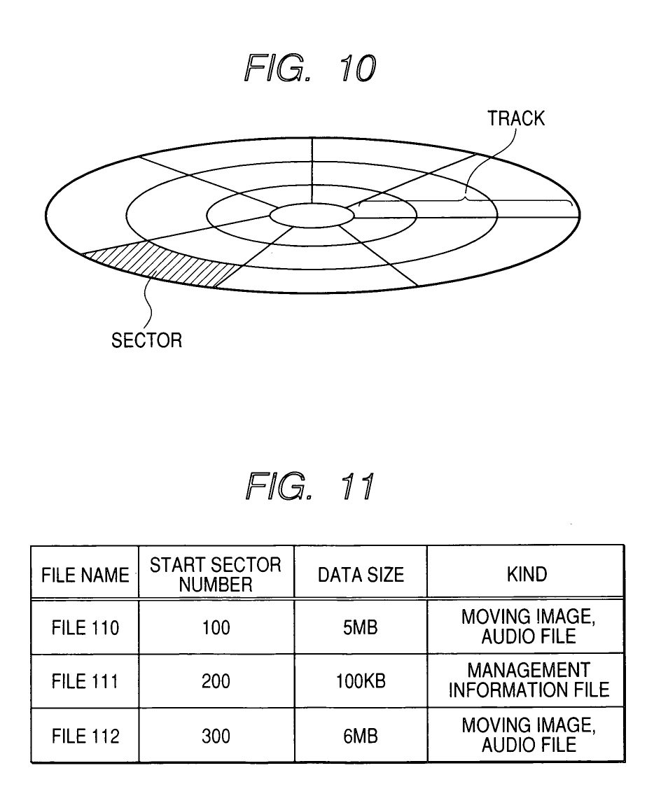

In recording moving image and audio data in a disk recording medium such as an HD or a DVD, the data is recorded on a file basis. FIG. 10 shows a data structure of a disk such as an HD or a DVD. Data on the disk is divided into concentric circles referred to as tracks. The track is further divided into arc-shaped segments referred to as sectors.

In FIG. 10, all the tracks have the same number of sectors. In this case, an information density is greater on the inner tracks than on the outer tracks. For this reason, the number of sectors on the outer track may be increased. Each of the sectors is assigned a number. When the data is registered as a file, information including a file name, a start sector number of the file, a data size (e.g., in bytes) occupied by the data, and kinds of the data is defined as file information and registered independently of the data. FIG. 11 shows an example of the file information.

(Time Map Information)

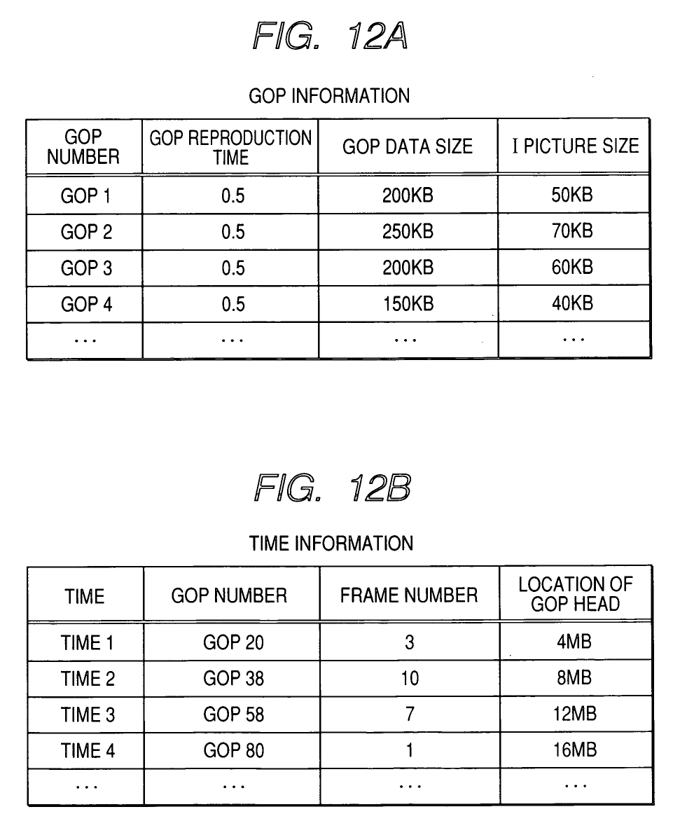

Time map information is a conversion table for converting reproduction time (e.g., in seconds) from a head of the data stream and a data size (in bytes) between each other, and composed of GOP information and time information as shown in FIGS. 12A and 12B. The GOP information is a table in which reproduction time (in seconds), a size (in bytes), an I picture size (in bytes), relative to all the GOP included in moving image data are listed.

The time information is a table in which corresponding GOP's, frame numbers indicating a reproduction order in a GOP, a location of GOP head from the head of moving image and audio data (in bytes) are listed at a predetermined interval (e.g. every 10 seconds). The reproduction time from the head of the moving image and audio data can be converted into a location in byte by using the GOP information and the time information.

(Explanation on a Play List)

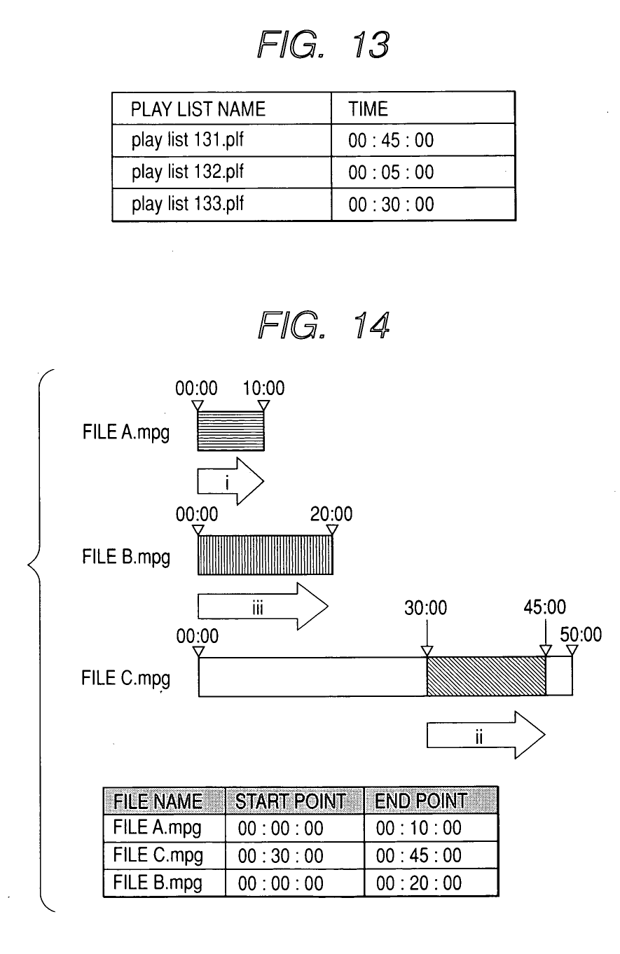

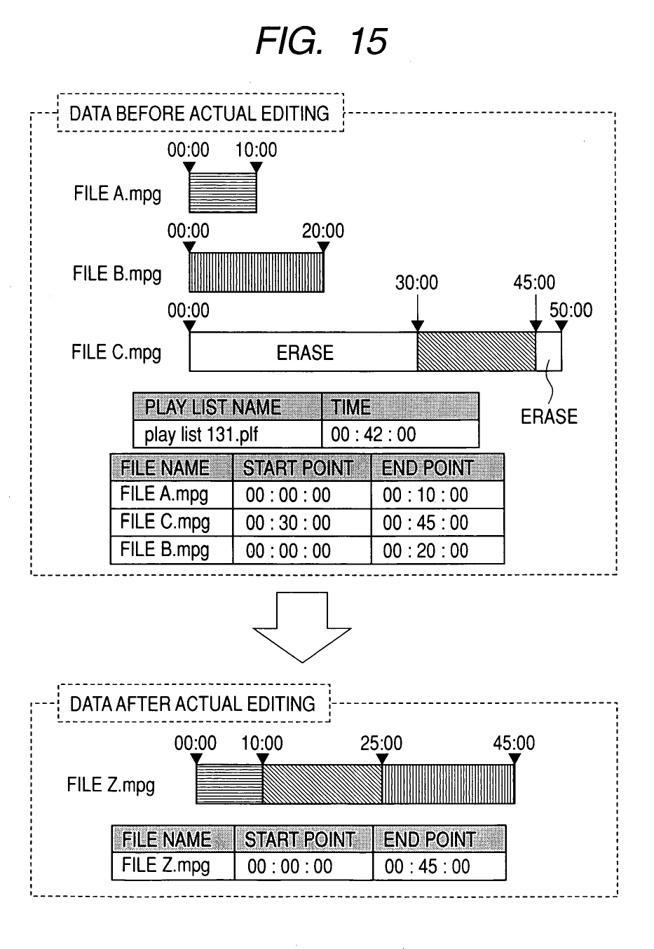

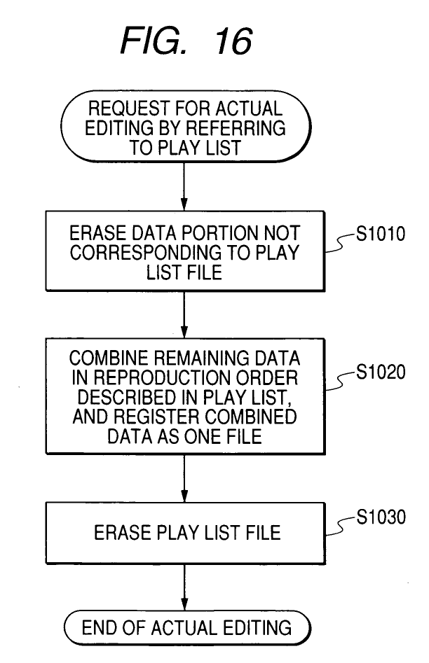

A play list provides a virtual editing, which is different from an actual editing in which data is actually moved, modified, and deleted. The play list is explained by referring to FIGS. 13 and 14. A play list shows a method with which a user records a reproduction order. FIG. 13 shows a table of play lists. FIG. 14 illustrates, by use of files, a reproduction order of a play list 131 of FIG. 13.

In the play list 131, a start point and end point of each file are designated, such as 0 to 10 minutes in FILEA, 30 to 45 minutes in FILEC, and 0 to 20 minutes in FILEB, to be stored in a play list file. File information and time map information are referred to based on the time registered in the play list file, and the designated location on the disk is accessed, allowing reproduction of data.

In FIG. 13, the data is continuously reproduced in the order indicated by the arrows (i) to (iii) of FIG. 14. In this way, a function of the play list is utilized to make it possible to continuously reproduce the play list by combining plural parts of the file. Also, in the play list, data can be designated on a frame (picture) basis, and a user can designate time with enough accuracy for picture-basis time designation.

(Transfer of Data Registered in Play List)

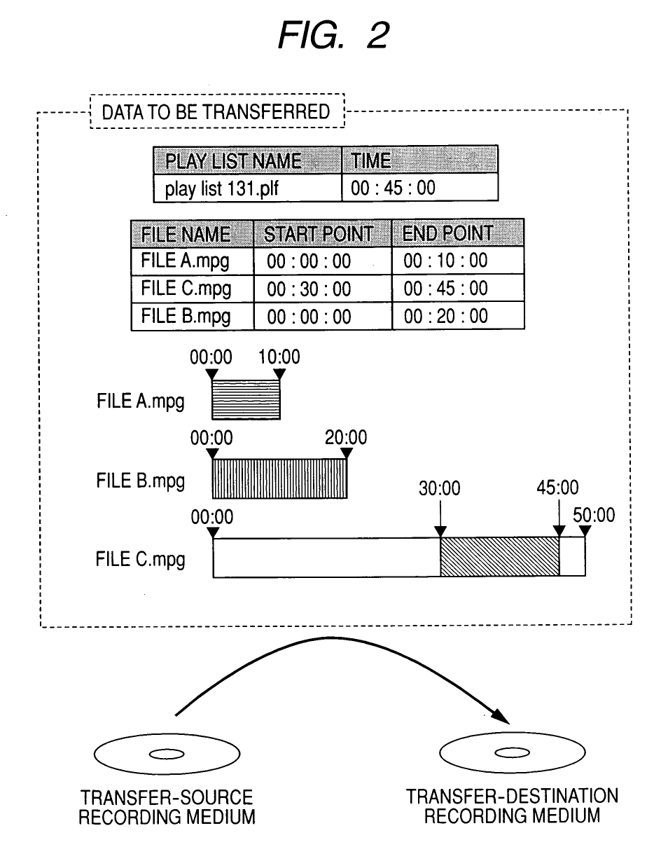

FIG. 2 illustrates a method of transferring a play list, with which the play list relative to a plurality of files that are recorded in a conventional recording and reproducing devices can be used in the transfer-destination device in the same manner as in the transfer-source device. A play list file in which the play list is registered and a moving image and audio file relative to the play list file are all transferred.

(Information Recording and Reproducing Device According to the Present Invention)

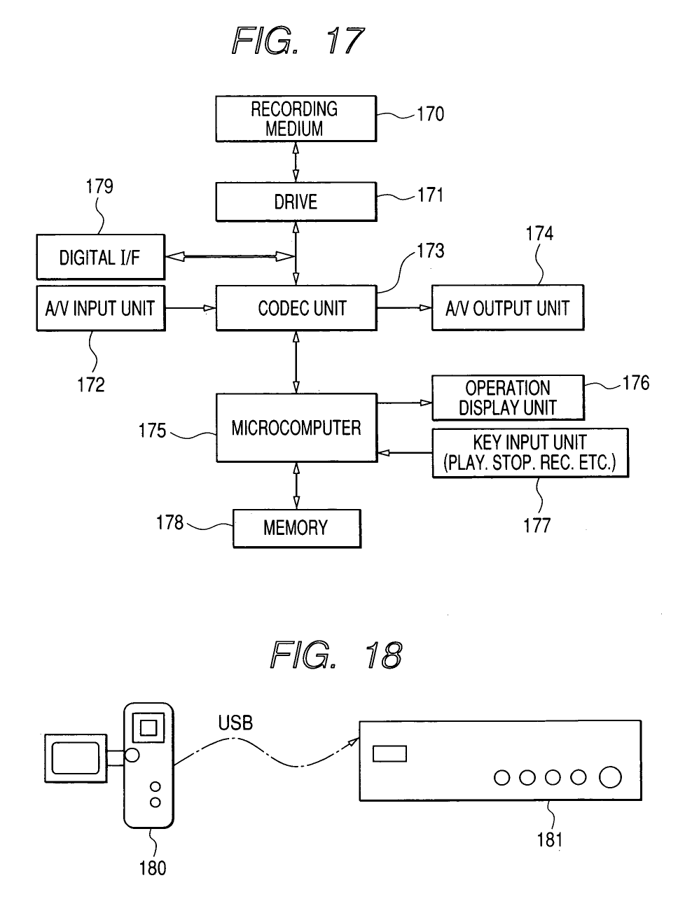

FIG. 17 is a block diagram showing an embodiment of an information recording and reproducing device according to the present invention. The information recording and reproducing device mainly includes: a recording medium 170 such as an HD, an optical disk, and a semiconductor memory; a drive 171 for driving the recording medium 170, a codec unit 173 for performing encoding and decoding of data; a microcomputer 175 for controlling parts of the device; and a memory 178 for recording information necessary for the device. In addition, an A/V input unit is denoted by 172, an A/V output unit is denoted by 174, an operation display unit is denoted by 176, and a key input unit is denoted by 177.

In recording data, moving image and audio data obtained by capturing data distributed by a broadcast station through a tuner, or recorded by a camcorder, is inputted from the A/V input unit 172, and the microcomputer 175 controls the codec unit 173 to encode the data into data that can be recorded onto the recording medium, to thereby record the resultant data.

In reproducing the data, the microcomputer 175 is controlled so that the digital signal read out from the recording medium 170 is decoded in the codec unit 173 into data that can be displayed on a monitor of television or the like that is connected to the A/V output unit 174.

In inputting digital data from another recording and reproducing device, data inputted through a digital I/F 179 is recorded onto the recording medium 170. In transferring data to another recording and reproducing device, the microcomputer 175 controls the recording medium 170 so that the data to be transferred is read out to be outputted through the digital I/F 179.

### First Embodiment

FIG. 18 shows an overview of a case where a digital interface such as USB is used to transfer data between a recording and reproducing device (transfer source device) 180 such as a camcorder having a structure as shown in FIG. 17 and a stationary recording and reproducing device (transfer destination device) 181 such as a HDD recorder.

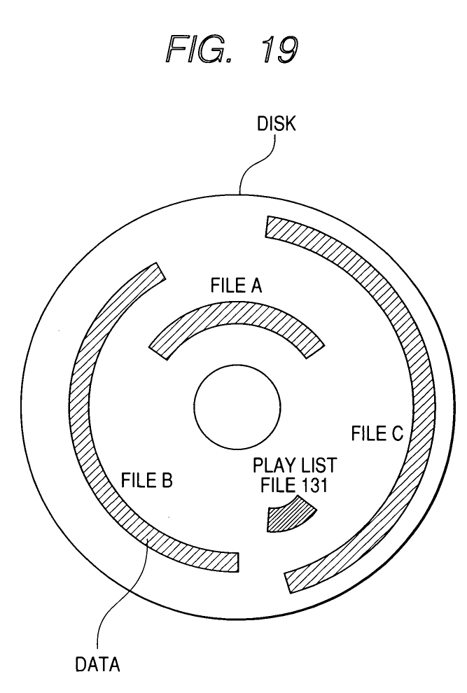

FIG. 19 shows an overview of the recording medium 170 that is included in the transfer source device 180 and has the file data shown in FIG. 14 recorded thereto.

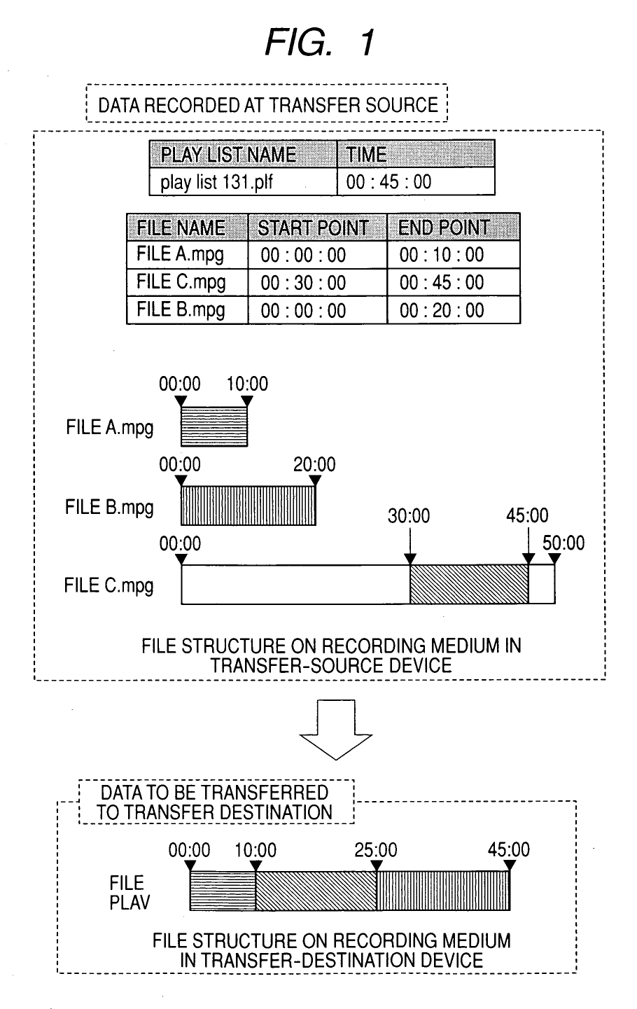

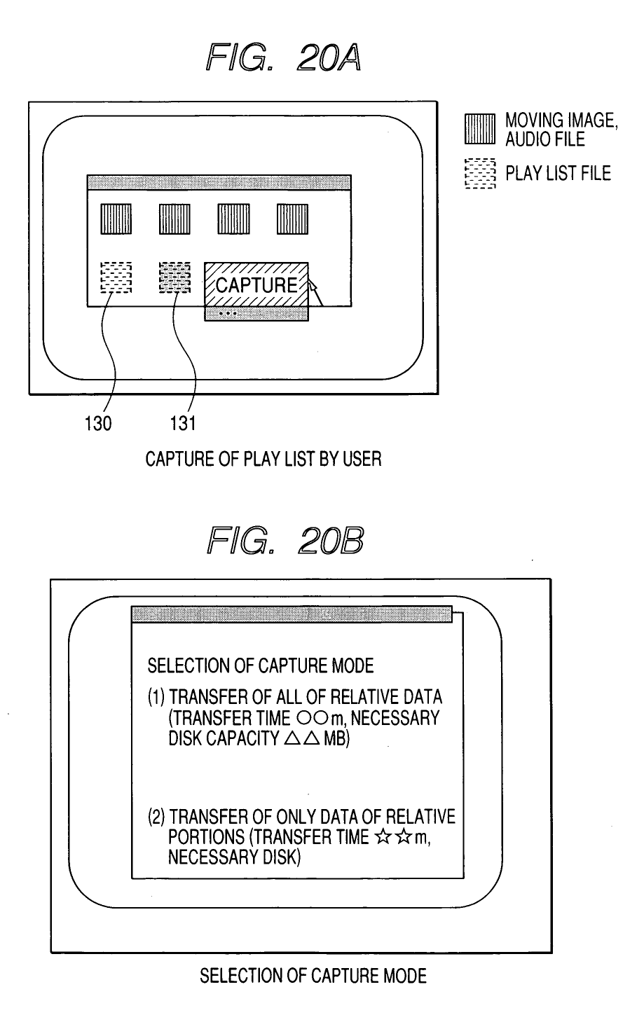

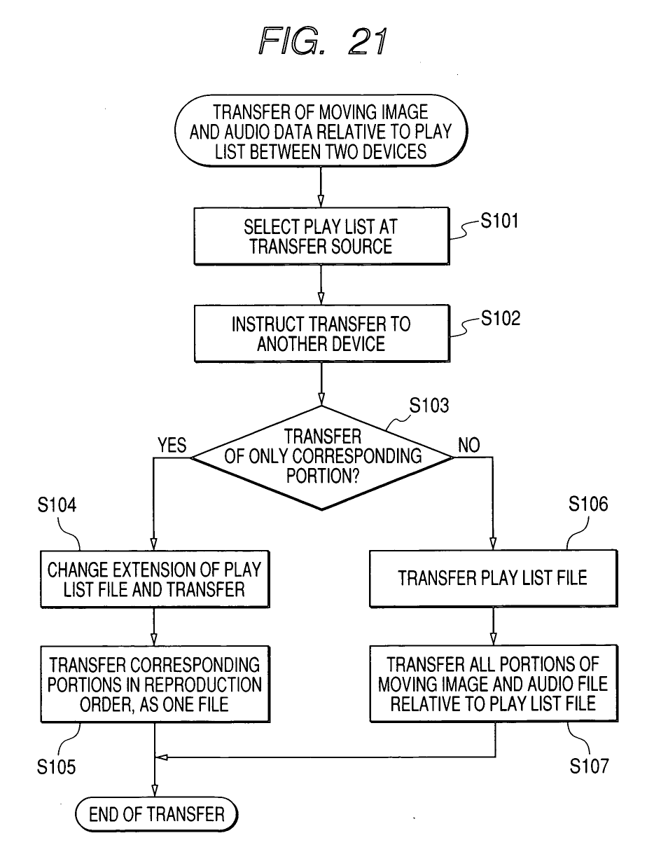

FIG. 1 shows a transfer method according to the present invention. FIG. 21 is a flowchart showing the transfer method according to the present invention. When the user is to transfer portions relative to the play list file 131 recorded in the recording medium 170 within the transfer source device 180, to the transfer destination device 181, the user makes a request for transfer by using the operation display unit 176 as shown in FIGS. 20A and 20B and operating a button provided to the transfer source device 180 to designate the play list file 131 (steps S101 and S102) Here, numeral 130 also denotes a play list file.

The user selects as to whether all data relative to a play list file 201 are to be transferred or only data portions corresponding to the play list file 131 are to be transferred (step S103). Displayed at this time are a time required for transfer in each mode and a data capacity required for the transfer destination.

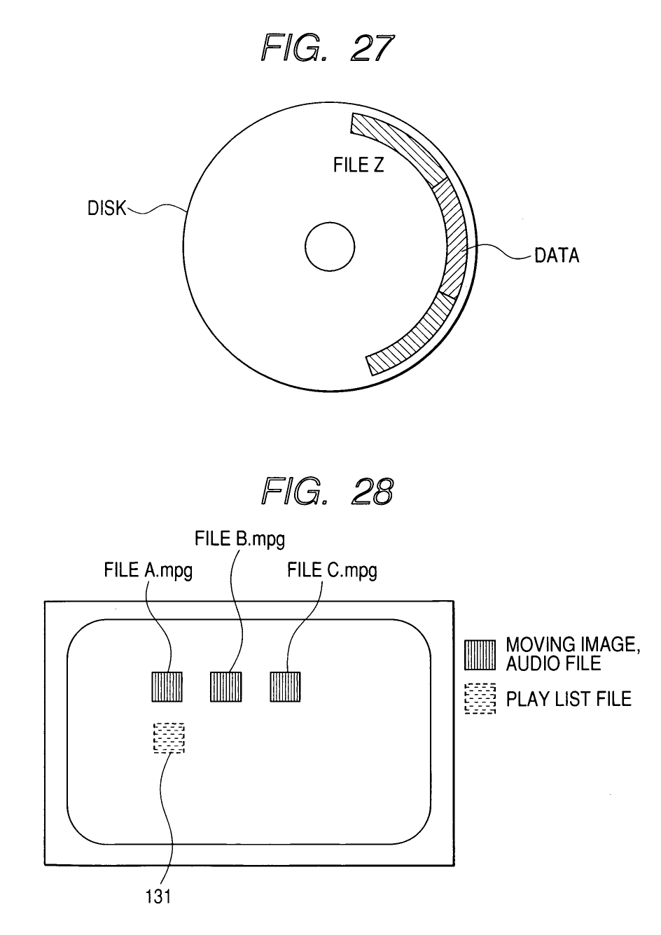

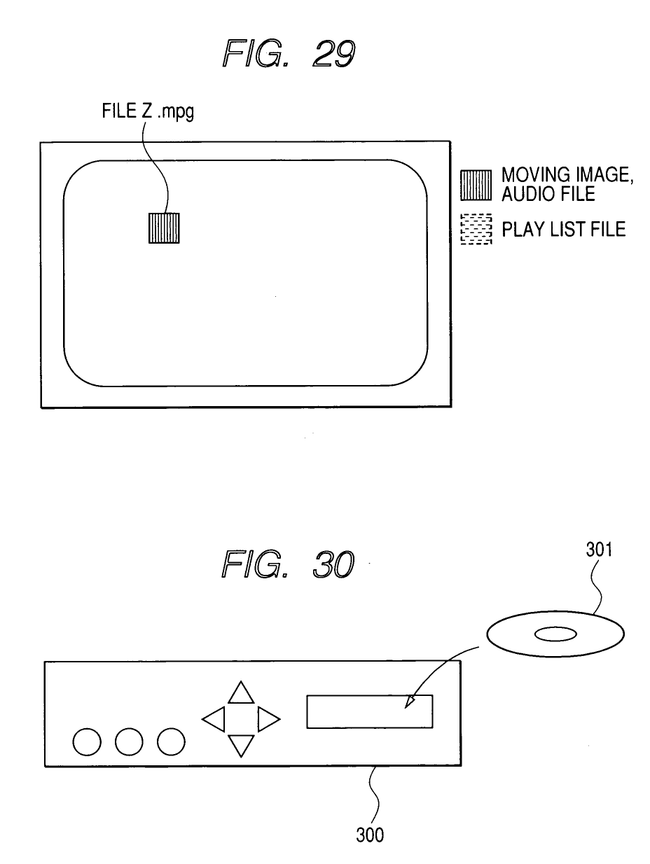

In FIG. 20B, if “(2) transfer of only data of relative portions” is selected, moving image and audio data is recorded from the recording medium 170 of the transfer source device 180 via the digital I/F 179 thereof to the recording medium 170 of the transfer destination device 181 via the digital I/F 179 thereof, in a reproduction order described in the play list file 131 (all of FILEA.mpg→part of FILEC.mpg→all of FILEB.mpg), and after the transfer, one moving image and audio file is registered (steps S104 and S105). The moving image and audio file name to be used is obtained by changing only the extension of the file name of the play list file within the transfer source device 180 (“play list 131.plf”→“play list 131.mpg”) (steps S104 and S105). After the transfer, the moving image and audio file is recorded in the recording medium 170 at the transfer destination as shown in FIG. 27. FIG. 29 shows the file structure of the transfer source device 180 when viewed from the user.

In FIG. 20B, if “(1) transfer of all of relative data” is selected, all files of FILEA.mpg, FILEB.mpg, FILEC.mpg, and “play list 131.plf” are recorded from the recording medium 170 of the transfer source device 180 via the digital I/F 179 thereof to the recording medium 170 of the transfer destination device 181 via the digital I/F 179 thereof. The transfer order may be mixed on a file basis. FIG. 28 shows the file structure of the transfer destination device 181 when viewed from the user (steps S106 and S107).

In FIG. 1, when stream data of the recorded files of FILEA.mpg, FILEB.mpg, and FILEC.mpg have amount of encoded data of 6 Mbps, a data amount to be transferred according to the present invention is obtained as below.

$$6 \text{,} 000 \text{,} 000 ( bits \text{/} sec ) \times ( 45 ( min ) \times 60 ( sec ) ) = 1.62 \times {10}^{10} ( bits ) \qquad ( 3 )$$

Transfer of the data in a full speed mode of USB 1.0, which provides a transfer speed of 12 Mbps, requires the following transfer time.

$$1.62 \times {10}^{10} ( bits ) \div 12 \text{,} 000 \text{,} 000 ( bits \text{/} sec ) = 22.5 ( min ) \qquad ( 4 )$$

Accordingly, the transfer time reduces by about 15 minutes compared to the conventional method.

The location of the moving image and audio file designated in the play list file can be designated on a picture basis. Thus, a designated location does not necessarily coincide with a GOP boundary. It is determined whether or not a head portion location and a trailing portion location of a designated range coincide with GOP boundaries, and whether the head GOP of data to be transferred is a closed GOP or an open GOP. The determination results are used to change the range to be transferred.

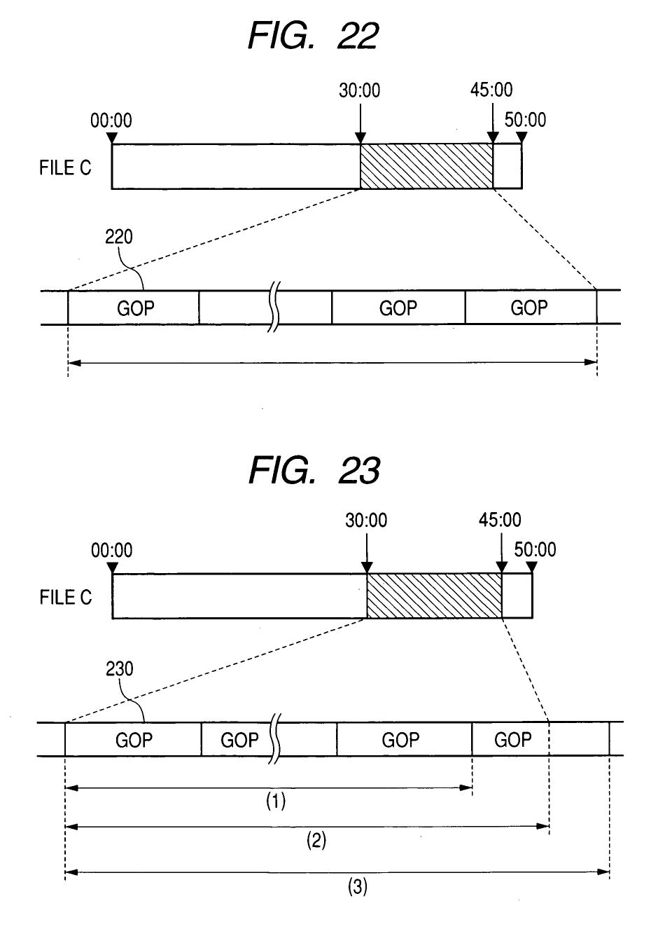

For example, it is determined upon transfer whether the head portion location and the trailing portion location of the designated range of FILEC.mpg, which is the moving image and audio file designated in the play list file 131, respectively coincide with GOP boundaries. If the designated head portion and the designated trailing portion respectively coincide with GOP boundaries as shown in FIG. 22, a designated range is transferred to the transfer destination as it is. If a GOP 220 is an open. GOP, a broken link flag is set in a GOP 220 header.

If the designated head portion coincides with a GOP boundary and the designated trailing portion does not coincide with a GOP boundary as shown in FIG. 23, the range to be transferred can be changed into the following range:
(1) from the head portion location of the designated range to a GOP boundary immediately before the trailing portion location of the designated range;
(2) from the head portion location of the designated range to the trailing portion location of the designated range; or
(3) from the head portion location of the designated range to a GOP boundary immediately after the trailing portion location of the designated range.

If a GOP 230 is an open GOP with the range to be transferred being (1), a broken link flag is set in a GOP 230 header.

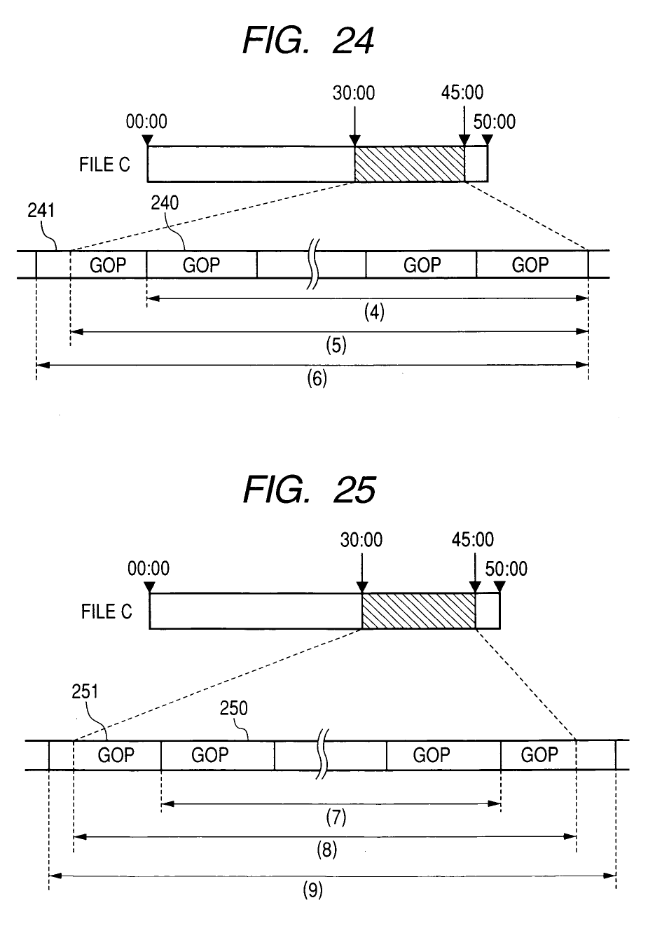

Further, if the designated head portion does not coincide with a GOP boundary and the designated trailing portion coincides with a GOP boundary as shown in FIG. 24, the range to be transferred can be changed into the following range:
(4) from a GOP boundary immediately after the head portion location of the designated range to the trailing portion location of the designated range;
(5) from the head portion location of the designated range to the trailing portion location of the designated range; or
(6) from a GOP boundary immediately before the head portion location of the designated range to the trailing portion location of the designated range.

If a GOP 240 is an open GOP with the range to be transferred being (4), a broken link flag is set in a GOP 240 header. If a GOP 241 is an open GOP with the range to be transferred being (5) or (6), a broken link flag is set in a GOP 241 header.

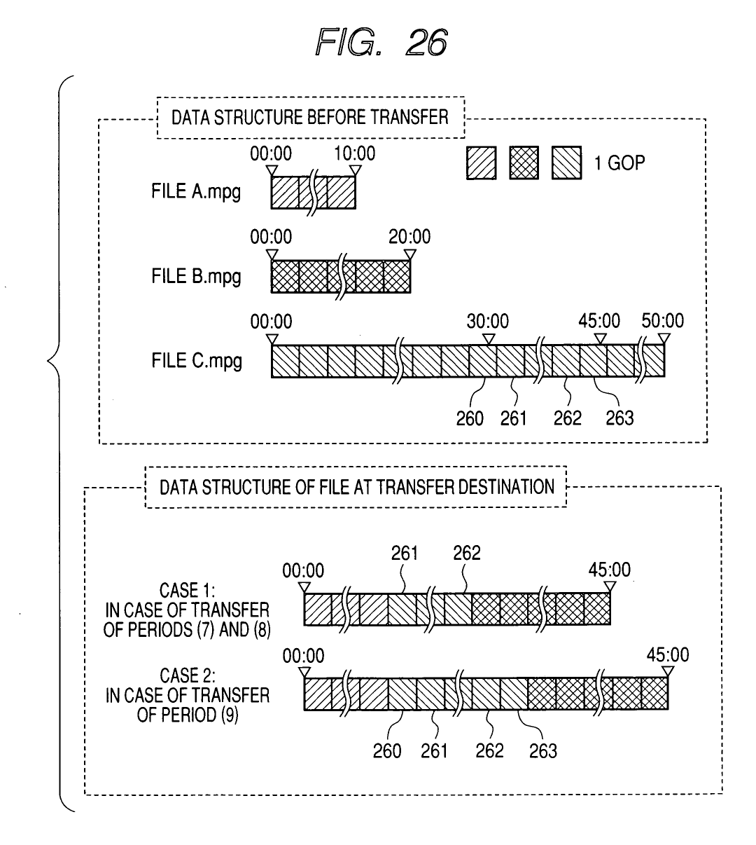

If neither the designated head portion nor the designated trailing portion coincides with a GOP boundary as shown in FIG. 25, the range to be transferred can be changed into the following range:
(7) from a GOP boundary immediately after the head portion location of the designated range to a GOP boundary immediately before the trailing portion location of the designated range;
(8) from the head portion location of the designated range to the trailing portion location of the designated range; or
(9) from a GOP boundary immediately before the head portion location of the designated range to a GOP boundary immediately after the trailing portion location of the designated range.

If a GOP 250 is an open GOP with the range to be transferred being (7), a broken link flag is set in a GOP 250 header. If a GOP 251 is an open GOP with the range to be transferred being (8) or (9), a broken link flag is set in a GOP 251 header.

If the range to be transferred is (2), (5), or (8), some GOP's cannot be formed completely, so some GOP's cannot be reproduced at the transfer destination. In such a case, the GOP's are erased at the transfer destination.

If the range to be transferred is (1) or (4), a little less than 1 GOP at maximum of moving image and audio data relative to the play list are not transferred. If, the range to be transferred is (7), a little less than 2 GOP's at maximum of moving image and audio data relative to the play list are not transferred. Alternatively, if the range to be transferred is (3) or (6), a little less than 1 GOP at maximum of excess data not relative to the play list are transferred to the transfer destination. If the range to be transferred is (9), a little less than 2 GOP's at maximum of excess data not relative to the play list are transferred to the transfer destination. However, when 1 GOP of data is set to have a reproduction time of 0.5 seconds, and when a little less than 2 GOP's at maximum of data has amount of encoded data of 6 Mbps, transfer of the data in a full speed mode of USB requires the following transfer time.

$$6 \text{,} 000 \text{,} 000 ( bits \text{/} sec ) \times 1 ( sec ) \div 12 \text{,} 000 \text{,} 000 ( bits \text{/} sec ) = 0.5 ( sec ) \qquad ( 5 )$$

This is not to impose such a large burden on a user.

FIG. 26 shows a data structure of a file before and after transfer in the case where the portion to be transferred is selected as shown in FIG. 25. Shown below are cases where the designated portion within FILEC.mpg has different structures after transfer.

Case 1: If the selected range to be transferred is (7) in FIG. 25, a GOP 260 and a GOP 263 are not transferred. GOP's within the range from the boundary of the head portion of a GOP 261 to the boundary of the trailing portion of a GOP 262 are transferred to the transfer destination as a part of a file to be recorded therein.

If the selected range to be transferred is (8) in FIG. 25, the designated range is transferred as it is, so parts of the GOP 260 and the GOP 263 are transferred. However, the parts are erased after the transfer, so the data structure after transfer has the GOP's within the range from the boundary of the head portion of the GOP 261 to the boundary of the trailing portion of the GOP 262 as a part of a file to be recorded therein.

Case 2: If the selected range to be transferred is (9) in FIG. 25, the data structure after transfer has the GOP's within the range from the boundary of the head portion of the GOP 260 to the boundary of the trailing portion of the GOP 263 as a part of a file to be recorded therein.

It should be noted that reference time information added upon multiplexing and time information added on an encoding basis differ depending on the transfer-source data files relative to the play list file. The method of transferring data from the transfer source according to the present invention includes a method of modifying the reference time information and the time information for encoding when the moving image and audio data of a plurality of files registered in the play list file before transfer are to be combined into one file, and a method of transferring the data portions as they are.

### Second Embodiment

A play list file and moving image and audio files relative thereto are recorded in a DVD recording medium 301 as shown in FIG. 30, or a removable recording medium such as a flash memory.

In this case, even when the content of the play list file is to be transferred to an HDD incorporated into an HDD-built-in information recording and reproducing device 300, it is possible to make selection between the transfer method according to the present invention as shown in FIGS. 1 and 2 and the conventional transfer method. However, in a device having a medium to which the play list file and moving image and audio files relative thereto are recorded, the medium needs to be processed to allow another device to access the files. This processing is called finalization for a DVD medium.

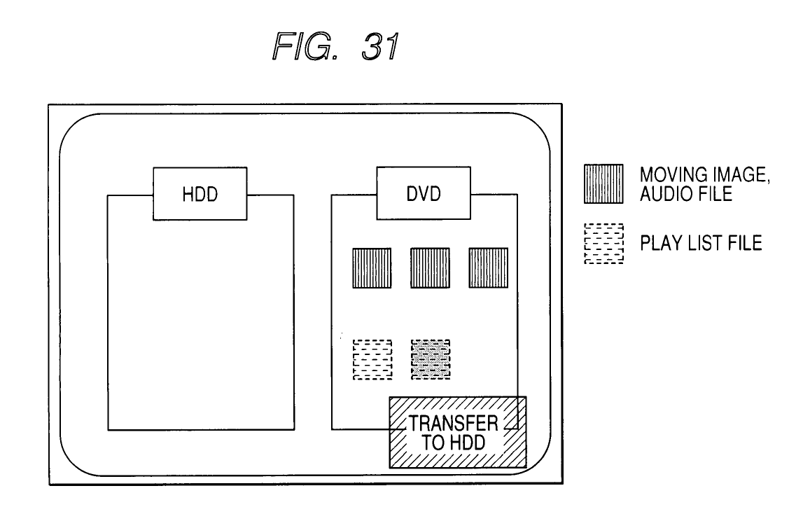

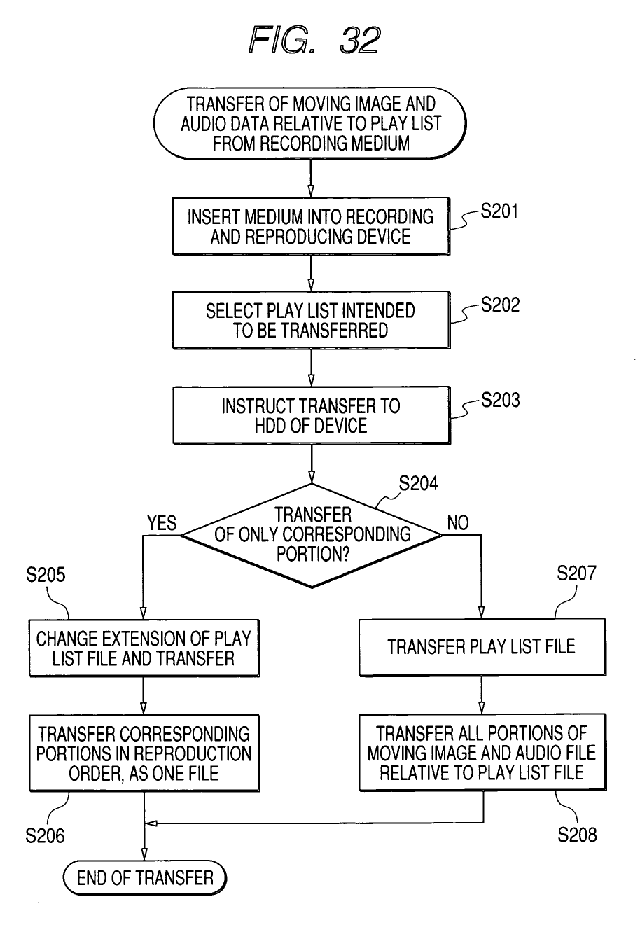

FIG. 31 shows an example of indication to transfer the play list file 131 to the HDD from a DVD medium 301 on which the play list and the moving image and audio data as shown in FIGS. 13 and 14 are recorded. FIG. 32 shows a flowchart thereof. The DVD medium 301 on which a play list file and moving image and audio files are recorded is inserted into the information recording and reproducing device 300. After that, as shown in FIG. 31, the play list file 131 is selected, and a setting button is pressed to call a pop-up window, through which indication is made to transfer the files to the HDD incorporated into the information recording and reproducing device 300 (steps S201 to S203). Then, the screen of FIG. 20B appears, which allows a user to select the transfer method (step S204).

If “(2) transfer of only data of relative portions” is selected, the moving image and audio data is recorded from the transfer-source DVD medium 301 to the HDD incorporated into the information recording and reproducing device 300 in the reproduction order described in the play list file 131 (all of FILEA.mpg→part of FILEC.mpg→all of FILEB.mpg), and after the transfer, one moving image and audio file is registered (steps S205 and S206). The moving image and audio file name to be used is obtained by changing only the extension of the file name of the play list file within the transfer source device 180 (“play list 131.plf”→“play list 131.mpg”) (steps S205 and S206).

In FIG. 20B, if “(1) transfer of all of relative data” is selected, all files of FILEA.mpg, FILEB.mpg, FILEC.mpg, and “play list 131.plf” are recorded from the transfer-source DVD medium 301 to the HDD incorporated into the information recording and reproducing device 300 (steps S207 and S208).

It should be noted that the present invention is not limited to the embodiments as described above, and may be variously modified without departing from the spirit of the present invention.

This application claims priority from Japanese Patent Application No. 2004-226805 filed Aug. 3, 2004, and Japanese Patent Application No. 2005-188455 filed Jun. 28, 2005 which are hereby incorporated by reference herein.

What is claimed is:

1. An information recording and reproducing device, comprising:
an information recording and reproducing circuit adapted to record and reproduce moving image and audio data and a play list file;
a registration circuit adapted to register the moving image and audio data on a recording medium as a file;
a creation circuit adapted to create a play list file having a reproduction order registered therein, the reproduction order being used for reproducing entire or a part of files registered in the recording medium in a desired order; and
an indication circuit adapted to, in a case where the play list file is to be transferred and recorded to a recording medium of another device, combine moving image and audio data portions registered in the play list file, and transfer and record the moving image and audio data portions to the recording medium as one moving image and audio file.

2. An information recording and reproducing method, comprising:
indicating that a play list having a reproduction order registered therein, the reproduction order being used for reproducing entire or a part of files having moving image and audio data registered therein in a desired order, is to be transferred and recorded from the recording medium containing the play list to another recording medium; and
indicating that, in a case where the play list is to be transferred and recorded, moving image and audio data portions registered in the play list are combined, and transferred and recorded to the another recording medium as one moving image and audio file.

3. An information recording and reproducing device, comprising:
a built-in recording medium;
an information recording and reproducing circuit adapted to record and reproduce moving image and audio data and a play list file; and
a transfer circuit adapted to, in a case where the play list having a reproduction order registered therein, the reproduction order being used for reproducing entire or a part of files having the moving image and audio data registered therein in a desired order, is to be transferred and recorded from the recording medium containing the play list to the built-in recording medium, combine moving image and audio data portions registered in the play list, and transfer and record the moving image and audio data portions to the built-in recording medium as one moving image and audio file.
